(19) United States
(12) Patent Application Publication
(10) Pub. No.: US 2025/0304450 A1
(43) Pub. Date: Oct. 2, 2025

(54) ADHESION-ASSISTED SEPARATION METHOD FOR FIBROUS CARBON NANOHORN AGGREGATE

(71) Applicant: NEC Corporation, Tokyo (JP)

(72) Inventor: Mayumi KOSAKA, Tokyo (JP)

(73) Assignee: NEC Corporation, Tokyo (JP)

(21) Appl. No.: 19/089,139

(22) Filed: Mar. 25, 2025

(30) Foreign Application Priority Data
Apr. 1, 2024 (JP) 2024-058570

(51) Int. Cl. C01B 32/18; B05D 1/12; B82Y 30/00; B82Y 40/00

(52) U.S. Cl. CPC C01B 32/18; B05D 1/12; B82Y 30/00; B82Y 40/00; B05D 2320/00; C01P 2004/03; C01P 2004/32; C01P 2004/45; C01P 2004/64

(57) ABSTRACT

An aspect of the present disclosure relates to an adhesion-assisted separation method for a fibrous carbon nanohorn aggregate, and the adhesion-assisted separation method includes providing a dispersion containing a carbon nanohorn aggregate mixture containing a fibrous carbon nanohorn aggregate on a base material including, on a surface of the base material, an intermediate layer having a functional group that enhances adhesiveness to the fibrous carbon nanohorn aggregate, and moving at least one of the dispersion on the intermediate layer or the base material.

This application is based upon and claims the benefit of priority from Japanese patent application No. 2024-058570, filed on Apr. 1, 2024, the disclosure of which is incorporated herein in its entirety by reference.

### TECHNICAL FIELD

The present invention relates to an adhesion method and a separation method for a fibrous carbon nanohorn aggregate.

### BACKGROUND ART

The single-walled carbon nanohorn is a cone-shaped carbon structure in which a graphene sheet is rolled up into a structure with a pointed horn-shaped tip with a tip angle of approximately 20°. Usually, single-walled carbon nanohorns are radially aggregated with conical tip portions facing outward to form a spherical carbon nanohorn aggregate having a diameter of about 100 nm.

In recent years, a fibrous carbon nanohorn aggregate has been discovered, and the fibrous carbon nanohorn aggregate has, unlike the spherical carbon nanohorn aggregate, a structure in which single-walled carbon nanohorns are radially aggregated and extend in a fibrous form. JP 6179678 B2 discloses a fibrous carbon nanohorn aggregate. Since the fibrous carbon nanohorn aggregate has characteristics such as high dispersibility and high electrical conductivity, it is expected to apply the fibrous carbon nanohorn aggregate to an electrically conductive material of a lithium ion battery, a high-capacity electric double layer capacitor electrode, a polymer actuator electrode, a sensor electrode, a catalyst carrier, a composite material, and the like.

### CITATION LIST

### Patent Literature

[PTL 1] JP 6179678 B2

### SUMMARY OF INVENTION

### Technical Problem

Fibrous carbon nanohorn aggregates (also referred to as “carbon nanobrush” and also described herein as “CNB”) are produced by laser ablation of an iron-containing carbon target, and at the same time, a large amount, equal to or more than 80%, of spherical carbon nanohorn aggregates (also described as “CNHs”) and about 10% to 15% of graphite or carbon fragments are also generated. Since the content of the fibrous carbon nanohorn aggregates in the products is around a few percent, it is necessary to separate and purify the carbon nanobrush from the other products in order to utilize the carbon nanobrush itself and evaluate the characteristics thereof.

The graphite and carbon fragments are different in size and density from the carbon nanohorn aggregate, and thus can be separated by a method of precipitation in a dispersion. However, there was a problem that it is difficult to separate only the fibrous carbon nanohorn aggregates because the spherical carbon nanohorn aggregates and the fibrous carbon nanohorn aggregates have the same diameter (about 0.1 μm) and similar properties such as density and catalyst content.

In view of the above-described problems, an object of the present invention is to provide a method for separating a fibrous carbon nanohorn aggregate.

### Solution to Problem

The inventor has found that there is a difference in adhesion force to a substrate or the like between a spherical carbon nanohorn aggregate (CNHs) and a fibrous carbon nanohorn aggregate (CNB). The present inventor has found that the fibrous carbon nanohorn aggregates can be separated by utilizing this difference in adhesion force. The present invention is based on such findings, and includes the following aspects.

An aspect of the present disclosure relates to an adhesion-assisted separation method for a fibrous carbon nanohorn aggregate, the adhesion-assisted separation method including
providing a dispersion containing a carbon nanohorn aggregate mixture containing a fibrous carbon nanohorn aggregate on a base material including, on a surface of the base material, an intermediate layer having a functional group that enhances adhesiveness to the fibrous carbon nanohorn aggregate, and
moving at least one of the dispersion on the intermediate layer or the base material.

An aspect of the present disclosure relates to an adhesion-assisted separation method for a fibrous carbon nanohorn aggregate, the adhesion-assisted separation method including
subjecting a fibrous carbon nanohorn aggregate to a production of defects, a modification with a functional group that enhances adhesiveness to a base material, and/or bonding with a compound that enhances adhesiveness to a base material,
providing, on the base material, a dispersion containing a carbon nanohorn aggregate mixture containing the fibrous carbon nanohorn aggregate subjected to the production of defects, the modification with a functional group that enhances adhesiveness to the base material, and/or the bonding with a compound that enhances adhesiveness to the base material, and
moving at least one of the dispersion on the base material or the base material.

An aspect of the present disclosure relates to an adhesion-assisted separation method for a fibrous carbon nanohorn aggregate, the adhesion-assisted separation method including
providing a dispersion containing a carbon nanohorn aggregate mixture containing a fibrous carbon nanohorn aggregate on a base material by spraying in an aerosol state.

### Advantageous Effects of Invention

According to the present invention, it is possible to provide the method for separating a fibrous carbon nanohorn aggregate from the carbon nanohorn aggregate mixture containing the fibrous carbon nanohorn aggregate.

### BRIEF DESCRIPTION OF DRAWINGS

FIG. 1 shows SEM images in a case where a carbon nanohorn aggregate mixture (graphite removed) dispersion is added dropwise onto a substrate and dried;

FIG. 2 is a schematic view of a spherical carbon nanohorn aggregate (carbon nanohorns (CNHs)) (left) and a fibrous carbon nanohorn aggregate (carbon nanobrush (CNB)) (right), and a schematic view illustrating an adhesion portion between the spherical carbon nanohorn aggregate and the substrate, and an adhesion portion between the fibrous carbon nanohorn aggregate and the substrate;

FIG. 3 is a schematic view illustrating aerosol droplets of a carbon nanohorn aggregate mixture dispersion;

FIG. 4A is an SEM image of CNB/CNHs adhesion on an intermediate layer (APTES) in Example 1;

FIG. 4B is an SEM image of CNB/CNHs adhesion on an intermediate layer (APTES) in Example 2; and

FIG. 5 is an SEM image of CNB/CNHs monodisperse adhesion in a case where an aerosol of a carbon nanohorn aggregate mixture dispersion in Example 12 is sprayed onto an intermediate layer (APTES).

### EXAMPLE EMBODIMENT

A fibrous carbon nanohorn aggregate (CNB) and a spherical carbon nanohorn aggregate (CNHs) have many similar parts in properties and the like, and similarly have horn portions protruding outward. However, while the spherical carbon nanohorn aggregate has horns radiating from a center point, the fibrous carbon nanohorn aggregate has horns from a center line in a test tube brush-like shape. Therefore, as illustrated in FIG. 2, the fibrous carbon nanohorn aggregate has a larger ratio and number of horns that enable contact with a plane. Horn portions of the spherical carbon nanohorn aggregate and the fibrous carbon nanohorn aggregate contain a large number of five-membered rings or seven-membered rings and have high reactivity, which thus contributes to adhesiveness to a base material. Therefore, the fibrous carbon nanohorn aggregate having a larger ratio and number of horn portions has higher adhesiveness to the base material. The present invention has a feature of separating the fibrous carbon nanohorn aggregate and the spherical carbon nanohorn aggregate by using the difference in adhesion to a plane due to such a structural difference.

In the present invention, separating the fibrous carbon nanohorn aggregates includes, in addition to separating the fibrous carbon nanohorn aggregates alone, increasing the ratio of the fibrous carbon nanohorn aggregates in a mixture containing the fibrous carbon nanohorn aggregates.

A method for separating a fibrous carbon nanohorn aggregate of the present invention includes a method for adhering a fibrous carbon nanohorn aggregate alone or a mixture in which the ratio of the fibrous carbon nanohorn aggregate is increased to a base material.

In the present specification, an “adhesion-assisted separation method” means a method for separating a fibrous carbon nanohorn aggregate by adhesion of a mixture containing the fibrous carbon nanohorn aggregate to a desired base material.

Hereinbelow, an example embodiment of the present invention will be described. Note that the example embodiment described below has technically preferable limitations for carrying out the present invention, but the scope of the present invention is not limited to the following.

### <Fibrous Carbon Nanohorn Aggregate>

A fibrous carbon nanohorn aggregate is referred to as a carbon nanobrush (CNB) and has a structure in which single-walled carbon nanohorns are radially aggregated and connected in a fibrous manner. The fibrous carbon nanohorn aggregate can maintain a fibrous shape even though an operation such as centrifugation or ultrasonic dispersion is performed, unlike a structure in which single-walled carbon nanohorns are simply connected in a series to appear fibrous. The single-walled carbon nanohorn is a cone-shaped carbon structure in which a graphene sheet is rolled up into a structure with a pointed horn-shaped tip with a tip angle of approximately 20°, a diameter of 1 nm to 5 nm, and a length of 30 nm to 100 nm. The carbon structure is a structure mainly containing carbon, and may contain a light element or a catalytic metal. The fibrous carbon nanohorn aggregate is a fibrous carbon structure, and generally has a diameter of 30 nm to 200 nm and a length of 0.2 μm to 100 μm, for example, 0.5 μm to 10 μm. The aspect ratio (length/diameter) of the fibrous carbon nanohorn aggregate is generally 4 to 4,000, for example, 5 to 3,500. A surface of the fibrous carbon nanohorn aggregate has protrusions of single-walled carbon nanohorns with a diameter of 1 nm to 5 nm and a length of 30 nm to 100 nm. The fibrous carbon nanohorn aggregate has high electrical conductivity because it has a feature of a structure in which highly electrically conductive single-walled carbon nanohorns are connected in a fibrous manner to form a long electrically conductive path. The fibrous carbon nanohorn aggregate also has high dispersibility, and has a high effect of imparting electrical conductivity.

The fibrous carbon nanohorn aggregate is formed by connecting carbon nanohorn aggregates of the seed type, bud type, dahlia type, petal-dahlia type, and petal type (graphene sheet structure). That is, one or a plurality of types of carbon nanohorn aggregates is contained in the fibrous structure. The seed type has a shape in which little or no horn-shaped protrusions are observed on a surface of an aggregate, the bud type has a shape in which some horn-shaped protrusions are observed on a surface of an aggregate, the dahlia type has a shape in which a large number of horn-shaped protrusions are observed on a surface of an aggregate, and the petal type has a shape in which petal protrusions are observed on a surface of an aggregate. The petal structure is a structure having a width of 50 nm to 200 nm, a thickness of 0.34 nm to 10 nm, and 2 to 30 graphene sheets. The petal-dahlia type is an intermediate structure between the dahlia type and the petal type. The shape and particle diameter of a carbon nanohorn aggregate to be produced vary depending on the type and flow rate of a gas.

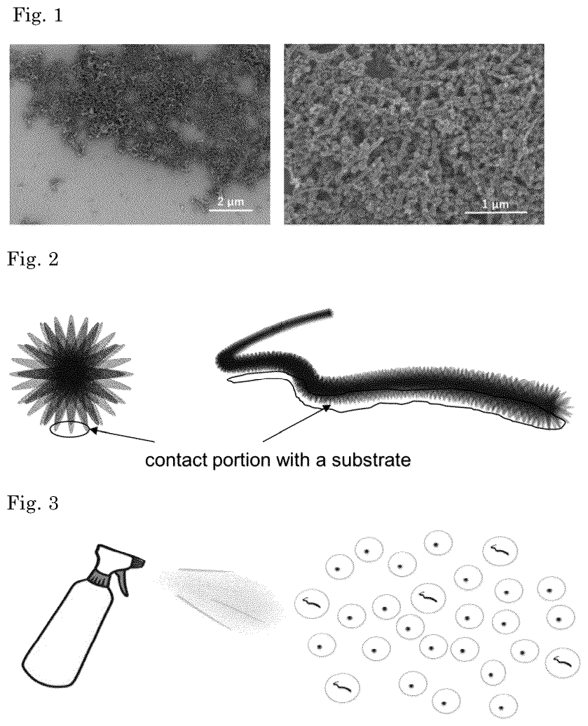

The fibrous carbon nanohorn aggregate is also described in detail in WO 2016/147909 A1. FIG. 1 and FIG. 2 of WO 2016/147909 A1 disclose transmission electron microscope images of the fibrous carbon nanohorn aggregates. In the fibrous carbon nanohorn aggregates illustrated in the transmission electron microscope images, single-walled carbon nanohorns (carbon nanohorn aggregate) that are radially aggregated are connected in a fibrous manner. The entire disclosure of WO 2016/147909 A1 is incorporated herein by reference.

### <Carbon Nanohorn Aggregate Mixture>

The separation method of the present invention is a method for separating fibrous carbon nanohorn aggregates from a carbon nanohorn aggregate mixture containing the fibrous carbon nanohorn aggregates (hereinafter, also simply referred to as the “carbon nanohorn aggregate mixture”). The carbon nanohorn aggregate mixture is preferably a mixture containing fibrous carbon nanohorn aggregates and spherical carbon nanohorn aggregates. In one example embodiment, the carbon nanohorn aggregate mixture is a carbon mixture that is produced when fibrous carbon nanohorn aggregates are produced by a laser ablation method described later or the like. The carbon nanohorn aggregate mixture is preferably a mixture containing, as main components, fibrous carbon nanohorn aggregates and spherical carbon nanohorn aggregates that are obtained by removing graphite and the like from such a carbon mixture.

The content of the fibrous carbon nanohorn aggregates in the carbon nanohorn aggregate mixture can be changed by changing the production conditions, and is preferably present in an amount of equal to or more than 2% by volume, and more preferably present in an amount of equal to or more than 4% by volume. The content of the fibrous carbon nanohorn aggregates can be measured by, for example, the particle size distribution measurement using a dynamic light scattering method for measuring the content ratio of the fibrous carbon nanohorn aggregates and the spherical carbon nanohorn aggregates. In a case where the carbon nanohorn aggregate mixture contains graphite, thermogravimetric analysis or the like for measuring the content of graphite can be combined.

The number ratio (“CNB/CNHs ratio”) of the fibrous carbon nanohorn aggregates (CNB) and the spherical carbon nanohorn aggregates (CNHs) in the carbon nanohorn aggregate mixture is preferably equal to or more than 0.0005, more preferably equal to or more than 0.001, and the upper limit is not particularly limited and is generally equal to or less than 0.005, for example, equal to or less than 0.003. The CNB/CNHs ratio can be measured by, for example, applying a dispersion of the carbon nanohorn aggregate mixture onto a base material and counting the number of fibrous carbon nanohorn aggregates and spherical carbon nanohorn aggregates in the carbon nanohorn aggregate mixture, or by converting the volume ratio of the fibrous carbon nanohorn aggregates and the spherical carbon nanohorn aggregates based on particle size distribution measurement using a dynamic light scattering method into a number ratio.

### <Preparation of Carbon Nanohorn Aggregate Mixture>

The carbon nanohorn aggregate mixture containing the fibrous carbon nanohorn aggregates can be produced by a laser ablation method or the like. In the laser ablation method, the carbon containing a catalyst is used as a target (referred to as a catalyst-containing carbon target), the target is heated by laser ablation in a nitrogen atmosphere, an inert atmosphere, hydrogen, carbon dioxide, or a mixed atmosphere while the target is rotated in a vessel in which the catalyst-containing carbon target is placed, and the target is evaporated. A process of cooling the evaporated carbon and catalyst proceeds to obtain fibrous carbon nanohorn aggregates. In the present invention, a carbon mixture produced by an arc-discharge method or a resistance heating method in addition to the laser ablation method can also be used as the carbon nanohorn aggregate mixture. However, the laser ablation method is more preferable from the viewpoint of continuous production at room temperature and atmospheric pressure.

The laser ablation method applied in the present invention is a method in which a target is irradiated with a laser beam in a pulsed or continuous manner, and when the irradiation intensity is equal to or higher than a threshold value, the target converts energy, resulting in plume formation, and a product is deposited on a substrate provided at downstream of the target or is produced in a space in an apparatus and recovered in a recovery chamber.

For the laser ablation, a CO₂ laser, a YAG laser, an excimer laser, a semiconductor laser, or the like can be used, and a CO₂ laser that allows for easy high-power scaling is most suitable. The CO₂ laser can be used with a power of 1 kW/cm² to 1,000 kW/cm², and can operate in both continuous irradiation and pulse irradiation. The continuous irradiation is more desirable for producing the fibrous carbon nanohorn aggregates. The laser beam is condensed by a ZnSe lens or the like and emitted. It is possible to continuously perform synthesis by rotating the target. Any target rotation speed may be set, and the target rotation speed is particularly preferably 0.1 rpm to 6 rpm. Graphitization can be suppressed in a case where the rotation speed is equal to or more than 0.1 rpm, and an increase in amorphous carbon can be suppressed in a case where the rotation speed is equal to or less than 6 rpm. In this case, the laser power is preferably equal to or more than 15 kW/cm², and is most effectively 30 kW/cm² to 300 kW/cm². In a case where the laser power is equal to or more than 15 kW/cm², the target is appropriately evaporated, and the fibrous carbon nanohorn aggregates are easily produced. In a case where the laser power is equal to or less than 300 kW/cm², an increase in amorphous carbon can be suppressed. The vessel (chamber) can be used at a pressure equal to or less than 13332.2 hPa (10000 Torr), but as the pressure approaches a near-vacuum level, carbon nanotubes are more likely to be produced, and the fibrous carbon nanohorn aggregates are not obtained. The pressure in the vessel (chamber) is preferably 666.61 hPa (500 Torr) to 1266.56 hPa (950 Torr), and more preferably around normal pressure (1013 hPa (1 atm≈760 Torr)), which is appropriate for mass synthesis and cost reduction. The irradiation area can also be controlled by the laser power and the degree of light focusing with a lens, and can be used within a range of 0.005 cm² to 1 cm².

As the catalyst, Fe, Ni, and Co can be used alone or in combination. The concentration of the catalyst may be appropriately selected, and is preferably 0.1% by mass to 10% by mass and more preferably 0.5% by mass to 5% by mass with respect to carbon. In a case where the concentration is equal to or more than 0.1% by mass, the fibrous carbon nanohorn aggregates are reliably produced. In a case where the concentration is equal to or less than 10% by mass, an increase in target cost can be suppressed.

It is possible to use the vessel with its interior at any temperature, and it is preferable to use the vessel with its interior at a temperature of 0° C. to 100° C., and more preferable to use the vessel with its interior at room temperature for mass synthesis and cost reduction.

A nitrogen gas, an inert gas, a hydrogen gas, a CO₂ gas, or the like is introduced into the interior of the vessel singly or in combination to obtain the above-described atmosphere. From the viewpoint of cost, a nitrogen gas and an Ar gas are preferable. These gases flow through the reaction vessel, and a produced substance can be recovered from the flow of the gases. Any flow rate of an atmosphere gas can be used, and a range of 0.5 L/min to 100 L/min is preferable and appropriate. In the evaporation process of the target, the gas flow rate is controlled to be constant.

The carbon nanohorn aggregate mixture is usually obtained, through the above-described reaction, as a carbon mixture of fibrous carbon nanohorn aggregates, spherical carbon nanohorn aggregates with a diameter of about 30 nm to 200 nm and a substantially uniform size, graphite with a size of 1 μm to several tens of m, and carbon fragments.

### Removal of Catalyst

Catalytic metals contained during the production of the carbon nanohorn aggregate mixture may be removed as needed. The catalytic metals can be removed because these are dissolved in nitric acid, sulfuric acid, or hydrochloric acid. The hydrochloric acid is suitable from the viewpoint of ease of use. The temperature at which the catalyst is dissolved may be appropriately selected, and in a case of sufficiently removing the catalyst, it is desirable that the catalyst is heated to a temperature equal to or higher than 70° C. The removal timing of the catalyst is not particularly limited, and for example, in a case of using the nitric acid or the sulfuric acid, the removal of the catalyst and the production of defects (formation of hole-openings) described later can be performed concurrently or continuously. It is desirable to perform pretreatment in order to remove a carbon coating because the catalyst may be covered with the carbon coating when the carbon nanohorn aggregate mixture is produced. The pretreatment is desirably performed in air at about 250° C. to 450° C. Hole-openings may be partially formed at a temperature equal to or higher than 300° C.

### Removal of Graphite

Graphite can be removed from the carbon mixture obtained by the above-described laser ablation method or the like as necessary. Specifically, the carbon mixture is dispersed in an organic solvent, and graphite is precipitated and separated. When the carbon mixture is dispersed in the organic solvent, the graphite is precipitated. On the other hand, the fibrous carbon nanohorn aggregates and the spherical carbon nanohorn aggregates float due to low density. By recovering the supernatant of the dispersion together with the suspended solid content, the graphite and the carbon nanohorn aggregate (fibrous carbon nanohorn aggregate and spherical carbon nanohorn aggregate) can be separated. For further treatment in other steps, the solvent is preferably removed from the recovered supernatant. The method for removing the solvent is not particularly limited, and for example, the solvent may be removed by heat.

The organic solvent preferably has a density lower than that of graphite. The density of the organic solvent is preferably less than 1 g/cm³, and more preferably less than 0.8 g/cm³. Examples of such an organic solvent include ethanol and 2-propanol. In a solvent having a relatively high density such as an aqueous solvent, it is difficult to separate graphite. The dispersion can be prepared by, for example, ultrasonic dispersion. When only graphite is precipitated by leaving the obtained dispersion to stand or centrifugally separating the obtained dispersion, and the suspended solid content is recovered from the dispersion, a carbon nanohorn aggregate mixture from which the graphite has been removed is obtained. The timing when the step of removing the graphite is not particularly limited, and this step is preferably performed before a separation step described later.

### <Carbon Nanohorn Aggregate Mixture Dispersion>

In the separation method of the present disclosure, a dispersion in which the carbon nanohorn aggregate mixture is dispersed in a dispersion medium (hereinafter, also referred to as a “carbon nanohorn aggregate mixture dispersion” or simply referred to as a “dispersion”) can be used.

As the dispersion medium of the dispersion, any of an organic solvent, an aqueous solvent, or a mixed solvent of an organic solvent and an aqueous solvent may be used.

Examples of the organic solvent include ethanol, 2-propanol, methyl ethyl ketone, toluene, and dichloroethane.

As the aqueous solvent, in addition to water, a surfactant solution obtained by adding a surfactant to water, phosphate buffered saline, or the like may be used. In a case where the carbon nanohorn aggregate mixture is dispersed in the surfactant solution, the surfactant adheres to the periphery of the monodispersed fibrous carbon nanohorn aggregates or spherical carbon nanohorn aggregates to form micelles. The spherical carbon nanohorn aggregates and the fibrous carbon nanohorn aggregates are dispersed in the surfactant solution, and almost nothing precipitates.

The surfactant is sufficient to be spread in a film shape on a carbon nanohorn aggregate in order to avoid the agglomeration of the carbon nanohorn aggregates. Examples of the surfactant include nonionic surfactants and ionic surfactants such as sodium dodecyl sulfate (SDS), sodium dodecylbenzene sulfate (SDBS), sodium cholate (SC), and sodium deoxycholate (DOC). In one aspect, it is preferable to use a nonionic surfactant.

The nonionic surfactant may be appropriately selected, and it is preferable to use one or a combination of a plurality of nonionic surfactants having a hydrophilic site that is not ionized and a hydrophobic site such as an alkyl chain, such as a nonionic surfactant having a polyethylene glycol structure represented by a polyoxyethylene alkyl ether-based compound and an alkyl glucoside-based nonionic surfactant. As such a nonionic surfactant, for example, a polyoxyethylene alkyl ether represented by the following Formula (1) (for example, Brij (trademark) or the like) is suitably used. The alkyl moiety may contain one or more unsaturated bonds.

CₙH₂ₙ₊₁(OCH₂CH₂)ₘOH (1)

(In formula, n is preferably 12 to 18, and m is 10 to 100 and preferably 20 to 100.)

In one aspect, it is more preferable to use nonionic surfactants defined by polyoxyethylene (n) alkyl ethers (wherein n is equal to or more than 20 and equal to or less than 100, and the alkyl chain length is equal to or more than C12 and equal to or less than C18) such as polyoxyethylene (23) lauryl ether, polyoxyethylene (20) cetyl ether, polyoxyethylene (20) stearyl ether, polyoxyethylene (10) oleyl ether, polyoxyethylene (10) cetyl ether, polyoxyethylene (10) stearyl ether, polyoxyethylene (20) oleyl ether, and polyoxyethylene (100) stearyl ether. N,N-bis[3-(D-gluconamido)propyl]deoxycholamide, n-dodecyl β-D-maltoside, octyl β-D-glucopyranoside, and digitonin can also be used.

As the nonionic surfactant, for example, it is possible to use polyoxyethylene sorbitan monostearate (molecular formula: C₆₄H₁₂₆O₂₆, trade name: Tween 60, manufactured by Sigma-Aldrich Co. LLC., or the like), polyoxyethylene sorbitan trioleate (molecular formula: C₂₄H₄₄O₆, trade name: Tween 85, manufactured by Sigma-Aldrich Co. LLC., or the like), octylphenol ethoxylate (molecular formula: C₁₄H₂₂O(C₂H₄O)ₙ, n=1 to 10, trade name: Triton X-100, manufactured by Sigma-Aldrich Co. LLC., or the like), polyoxyethylene (40) isooctylphenyl ether (molecular formula: C₈H₁₇C₆H₄₀(CH₂CH₂₀)₄₀H, trade name: Triton X-405, manufactured by Sigma-Aldrich Co. LLC., or the like), poloxamer (molecular Formula: C₅H₁₀O₂, Trade Name: Pluronic, manufactured by Sigma-Aldrich Co. LLC., or the like), polyvinylpyrrolidone (molecular formula: (C₆H₉NO)ₙ, n=5 to 100, manufactured by Sigma-Aldrich Co. LLC., or the like) and the like.

The concentration of the surfactant may be appropriately set according to a compound and the like to be used, is generally equal to or higher than the critical micelle concentration, and preferably higher than the critical micelle concentration, and for example, the concentration is preferably equal to or more than 0.001% by mass and more preferably equal to or more than 0.01% by mass, and is preferably equal to or less than 10% by mass and more preferably equal to or less than 5% by mass. In the present specification, the critical micelle concentration (CMC) refers to a concentration at which a surface tension is measured by varying the concentration of the aqueous surfactant solution using, for example, a surface tensiometer such as a Wilhelmy-type surface tensiometer at a constant temperature, with the concentration determined from the inflection point. In the present specification, the “critical micelle concentration” is a value at 25° C. under atmospheric pressure.

The content of the carbon nanohorn aggregate mixture in the carbon nanohorn aggregate mixture dispersion is preferably equal to or more than 10 μg/ml and more preferably equal to or more than 100 μg/ml, and is preferably equal to or less than 100 mg/ml and more preferably equal to or less than 10 mg/ml.

As described in the separation step described later, in a case where the carbon nanohorn aggregate mixture is adhered to the base material in a monodispersed state, the content of the carbon nanohorn aggregate mixture in the dispersion may be further reduced, and for example, the content of the carbon nanohorn aggregate mixture in the carbon nanohorn aggregate mixture dispersion is preferably equal to or less than 1 mg/ml, and more preferably equal to or less than 0.5 mg/ml.

The carbon nanohorn aggregate mixture dispersion can be prepared by adding the carbon nanohorn aggregate mixture to a dispersion medium and dispersing the carbon nanohorn aggregate mixture. In order to improve the dispersibility of the carbon nanohorn aggregate mixture, it is preferable to perform ultrasonic treatment.

### <Base Material>

A base material to which the carbon nanohorn aggregate mixture adheres is not particularly limited, and for example, any of substrate or film may be used.

The materials of the substrate and the film are not particularly limited, and examples thereof include inorganic materials such as Si, SiO₂-coated Si, SiO₂, SiN, glass, and metals such as silver, titanium, and gold, and organic materials such as parylene, polyimide, polyethylene, polypropylene, polystyrene, polyvinyl chloride, polyethylene terephthalate, an acrylonitrile styrene resin, an acrylonitrile butadiene styrene resin, a fluororesin, a methacrylic resin, and polycarbonate.

### <Separation Method>

The method for separating a fibrous carbon nanohorn aggregate of the present disclosure is an adhesion-assisted separation method utilizing a difference in adhesiveness between a fibrous carbon nanohorn aggregate and a spherical carbon nanohorn aggregate to a base material, and includes at least one of the following separation methods. It is also preferable to use two or more of the following methods in combination.

### (Method A)

One aspect of the adhesion-assisted separation method of the present disclosure includes:
a step of providing a dispersion containing a carbon nanohorn aggregate mixture containing a fibrous carbon nanohorn aggregate on a base material; and
a step of moving at least one of the dispersion on the base material or the base material.

The fibrous carbon nanohorn aggregate is likely to remain on the base material due to a larger number of horn portions in contact with a plane than the spherical carbon nanohorn aggregate. In contrast, the spherical carbon nanohorn aggregate having a smaller number of horn portions in contact with a plane is relatively likely to be detached from the base material. In a case where at least one of the dispersion or the base material is moved (the dispersion is moved relative to the base material), the adhesion of the spherical carbon nanohorn aggregate to the base material is reduced, and/or the spherical carbon nanohorn aggregate adhered to the base material is likely to be detached. As described above, by moving the dispersion relative to the base material, the difference in adhesiveness between the fibrous carbon nanohorn aggregate and the spherical carbon nanohorn aggregate to the base material can be more effectively utilized, and the separation performance (performance of increasing the ratio of the fibrous carbon nanohorn aggregate) can be enhanced.

In the present example embodiment, since the dispersion is sufficient to move relative to the base material, the dispersion may be moved, the base material may be moved, or both the dispersion and the base material may be moved.

The dispersion and/or the base material may be moved at the same time as the dispersion is provided on the base material, or the dispersion and/or the base material may be moved after the dispersion is provided on the base material (after the dispersion and the base material are brought into contact with each other).

The method for providing the dispersion on the base material is not particularly limited, and examples thereof include adding the dispersion dropwise onto the base material, applying the dispersion onto the base material, immersing the base material in a tank containing the dispersion, and flowing the dispersion on the base material.

The method for moving the dispersion and/or the base material is not particularly limited as long as the dispersion can move on the base material, and examples of the method include performing pulling, shaking, applying a centrifugal force, washing with a solvent, applying ultrasonic waves, vibrating, or blowing on the dispersion on the base material or the base material in the dispersion. Representative aspects are exemplified below.

(1) The base material and/or the dispersion are moved in an accelerated manner. The acceleration in this case is preferably equal to or more than 5 m/s² and more preferably equal to or more than 50 m/s², and is preferably equal to or less than 30,000 m/s² and more preferably equal to or less than 3,000 m/s². Examples of the aspect of movement in the accelerated manner include shaking off the dispersion provided on the base material, blowing off the dispersion provided on the base material, providing the dispersion on the base material installed at a desired inclination angle, and ejecting the dispersion by applying acceleration to the base material.

(2) The base material and/or the dispersion are moved by applying a centrifugal force. The centrifugal acceleration in this case is preferably equal to or more than 0.5×g and more preferably equal to or more than 5×g, and is preferably equal to or less than 3,000×g and more preferably equal to or less than 300×g. Examples of the aspect of movement by applying a centrifugal force include moving the dispersion provided on the base material by using a turntable such as a spin coater that rotates about a rotation axis, introducing the dispersion onto the base material attached to a rotating disk in which a disk or the like rotates around an axis and moving the dispersion, and introducing the dispersion onto the base material installed in a device such as a centrifugal separator in which a centrifugal force is vertically applied to the base material and moving the dispersion.

(3) The base material and/or the dispersion are moved in a manner other than the accelerated manner, for example at a constant speed. The speed in this case is preferably equal to or more than 0.1 m/s and more preferably equal to or more than 1 m/s, and is preferably equal to or less than 30,000 m/s and more preferably equal to or less than 3,000 m/s. Examples of the aspect of moving the base material and/or the dispersion at a constant speed include continuously providing the dispersion on the base material, washing away the dispersion on the base material with a solvent (examples of the solvent include solvents used in a washing step described later), moving the base material immersed in the dispersion in the vertical direction up and down, moving the base material immersed in the dispersion in the horizontal direction back and forth or left and right (horizontal direction), and rotating the base material horizontally immersed in the dispersion in the horizontal direction.

(4) The base material and/or the dispersion are vibrated. The vibration frequency in this case is preferably equal to or more than 5 Hz and more preferably equal to or more than 50 Hz, and is preferably equal to or less than 10 kHz and more preferably equal to or less than 1 kHz. Ultrasonic waves may be applied. Examples of the aspect of vibrating the base material and/or the dispersion include vibrating the base material in contact with the dispersion, and applying vibration to the dispersion in which the base material is immersed.

It is also preferable to combine two or more aspects of moving the base material and/or the dispersion. Examples of such a method include a method of immersing the base material in the dispersion, and (3) moving the base material up and down or moving the base material in the horizontal direction while (4) applying ultrasonic waves to the dispersion.

### (Method B)

An example embodiment of the adhesion-assisted separation method of the present disclosure includes providing a dispersion containing a carbon nanohorn aggregate mixture on a base material including, on a surface of the base material, an intermediate layer having a functional group that enhances adhesiveness to the fibrous carbon nanohorn aggregate.

Intermediate Layer Having Functional Group that Enhances Adhesiveness to Fibrous Carbon Nanohorn Aggregate

In the present example embodiment, an intermediate layer to which the fibrous carbon nanohorn aggregate is likely to be adhered is formed on the surface of the base material, and the carbon nanohorn aggregate mixture dispersion is provided on the intermediate layer. By using such an intermediate layer, the adhesiveness of the fibrous carbon nanohorn aggregate to the base material can be improved. Although such an intermediate layer also enhances the adhesiveness of the spherical carbon nanohorn aggregate to the base material, the fibrous carbon nanohorn aggregate has a larger number of horn portions that contribute to the adhesion to the base material, resulting in a higher adhesion enhancement effect. Accordingly, the difference in adhesiveness between the fibrous carbon nanohorn aggregate and the spherical carbon nanohorn aggregate to the base material is further increased, and the separation efficiency can be enhanced.

The material of the intermediate layer is preferably a compound having both a partial structure adhering to the surface of the base material and a functional group having high adhesiveness to the fibrous carbon nanohorn aggregate. Here, not only chemical bonding but also various intermolecular interactions such as electrostatic interaction, surface adsorption, hydrophobic interaction, van der Waals force, and hydrogen bonding may be used for adhesion between the fibrous carbon nanohorn aggregate and the functional group.

Examples of the partial structure adhering to the surface of the base material in the material of the intermediate layer include an alkoxysilyl group (SiOR), SiOH, and a hydrophobic moiety or hydrophobic group. Examples of the hydrophobic moiety or hydrophobic group include a methylene group (methylene chain) and an alkyl group, each having a carbon number equal to or more than one, preferably equal to or more than two, preferably equal to or less than 20, and more preferably equal to or less than 10.

Examples of the functional group having high adhesiveness to the fibrous carbon nanohorn aggregate in the material of the intermediate layer include amino groups such as a primary amino group (—NH₂), a secondary amino group (—NHR₁), and a tertiary amino group (—NR₁R₂), an ammonium group (—NH₄), a carboxy group (—COOH), a hydroxy group (—OH), a carbonyl group (—C(═O)—), an imino group (═NH), an imide group (—C(═O)—NH—C(═O)—), an amide group (—C(═O)NH—), a sulfo group (—SO₃H), a ferrocenyl group, an epoxy group, an isocyanurate group, an isocyanate group, a ureido group, a sulfide group, and a mercapto group.

The material of such an intermediate layer is not particularly limited, and examples thereof include a silane coupling agent. Examples of the silane coupling agent include silane coupling agents (aminosilane compounds) having an amino group and an alkoxysilyl group, such as 3-aminopropyltrimethoxysilane, 3-aminopropylmethyltriethoxysilane, 3-aminopropylmethyltrimethoxysilane, 3-aminopropyltriethoxysilane (APTES), 3-(2-aminoethyl)aminopropyltrimethoxysilane, N-(2-aminoethyl)-3-aminopropyltrimethoxysilane, N-2-(aminoethyl)-3-aminopropylmethyltrimethoxysilane, and N-(2-aminoethyl)-3-aminopropylmethyldimethoxysilane;
silane coupling agents having an epoxy group and an alkoxysilyl group, such as 3-glycidoxypropyltrimethoxysilane, 3-glycidoxypropyltriethoxysilane, 3-glycidoxypropylmethyldimethoxysilane, 3-glycidoxypropylmethyldiethoxysilane, 2-(3,4-epoxycyclohexyl)ethyltrimethoxysilane, 3-glycidoxypropyldiethoxysilane, and triethoxy(3-glycidyloxypropyl)silane;
isocyanurate-based silane coupling agents such as tris-(trimethoxysilylpropyl)isocyanurate;
ureide-based silane coupling agents such as 3-ureidopropyltrialkoxysilane;
mercapto-based silane coupling agents such as 3-mercaptopropylmethyldimethoxysilane, 3-mercaptopropyltrimethoxysilane, and 3-mercaptopropyltriethoxysilane;
sulfide-based silane coupling agents such as bis(triethoxysilylpropyl)tetrasulfide; and
isocyanate-based silane coupling agents such as 3-isocyanate propyltriethoxysilane.

Silane coupling agents having an amino group (aminosilane compounds) are particularly preferable because of good bondability to the fibrous carbon nanohorn aggregate.

Other examples of the material of the intermediate layer include a polymer (for example, a cationic polymer) having a partial structure capable of adhering to a base material and a partial structure capable of adhering to the fibrous carbon nanohorn aggregate, and a self-assembled monolayer (for example, thiol derivatives and phosphonic acid derivatives).

Examples of such a polymer include poly(N-methylvinylamine), polyvinylamine, polyallylamine, polyallyldimethylamine, polydiallylmethylamine, polydiallyldimethylammonium chloride, polydiallyldimethylammonium trifluoromethanesulfonate, polydiallyldimethylammonium nitrate, polydiallyldimethylammonium perchlorate, polyvinylpyridinium chloride, poly(2-vinylpyridine), poly(4-vinylpyridine), polyvinylimidazole, poly(4-aminomethylstyrene), poly(4-aminostyrene), polyvinyl(acrylamido-co-dimethylaminopropylacrylamide), polyvinyl(acrylamido-co-dimethylaminoethylmethacrylate), polyethyleneimine (PEI), DAB-Am and polyamidoamine dendrimers, polyaminoamide, polyhexamethylenebiguanide, polydimethylamine-epichlorohydrin, products of alkylation of polyethyleneimine with methyl chloride, products of alkylation of polyaminoamide with epichlorohydrin, cationic polyacrylamides with cationic monomers, formalin condensates of dicyandiamides, dicyandiamides, polyalkylene polyamine polycondensates, natural cationic polymers (for example, partially deacetylated chitin, chitosan, chitosan salts, and the like), synthetic polypeptides (for example, including, polyasparagine, polylysine, polyglutamine, and polyarginine).

Among such polymers, the cationic polymers having an amino group and a hydrophobic group or hydrophobic moiety are preferable from the viewpoint of adhesiveness to the fibrous carbon nanohorn aggregate. Examples of such cationic polymers include polylysine.

The “self-assembled monolayer” refers to a molecular layer formed on the surface of the base material in a highly oriented manner by self-assembling. The self-assembled monolayer is preferably a compound containing a functional group having high affinity with the base material and a functional group capable of adhering to the fibrous carbon nanohorn aggregate. The compound that forms the self-assembled monolayer may be appropriately selected depending on the base material and is not particularly limited, and for example, for a surface containing gold, silver, or alloys thereof, or a plated metal surface thereof, a functional group containing a sulfur atom is preferable from the viewpoint of affinity, and a thiol derivative having a thiol group (—SH) is preferable from the viewpoint of handleability, availability, and the like. In the thiol derivative, functional groups other than thiol are not particularly limited. Examples of the compound having excellent adhesiveness to the fibrous carbon nanohorn aggregate include, but are not limited to, compounds having amide groups such as 10-amido-1 decanethiol, 7-amido-1 heptanethiol, and 5-amido-1 penetanethiol; compounds having carboxy groups such as 15-carboxy-1-pentadecanethiol, 10-carboxy-1-decanethiol, 7-carboxy-1-heptanethiol, and 5-carboxy-1-pentanethiol; and compounds having hydroxy groups such as 16-hydroxy-1-hexadecanethiol, 11-hydroxy-1-undecanethiol, 8-hydroxy-1-octanethiol, and 6-hydroxy-1-hexanethiol.

In a case where a material having an amino group as a functional group is used for the intermediate layer, the amino group may enhance the adhesiveness not only of the fibrous carbon nanohorn aggregate but also of the spherical carbon nanohorn aggregate to the base material, and the separation performance may be deteriorated due to the difference in adhesiveness to the base material in some cases. In such a case, it may be preferable to use a compound having a functional group other than an amino group for the intermediate layer. Examples of a preferable functional group in such a case include an amide group, a carboxy group, and a hydroxy group.

The thickness of the intermediate layer may be appropriately set depending on the material to be used, and the like, and is preferably equal to or more than 1 nm, and more preferably equal to or more than 2 nm from the viewpoint of increasing the adhesion force of the fibrous carbon nanohorn aggregate. The upper limit is not particularly limited, and for example, equal to or less than 100 nm, preferably equal to or less than 50 nm, and more preferably equal to or less than 10 nm.

The above-described intermediate layer may enhance the adhesiveness not only of the fibrous carbon nanohorn aggregate but also of the spherical carbon nanohorn aggregate to the base material in some cases. In order to prevent the spherical carbon nanohorn aggregate from remaining excessively due to the enhanced adhesion force by the intermediate layer, it may be more efficient to use an intermediate layer with a very small thickness and density. In such a case, the thickness of the intermediate layer is preferably equal to or more than 0.1 nm, and more preferably equal to or more than 0.2 nm. The upper limit is not particularly limited, and for example, equal to or less than 5 nm, preferably equal to or less than 2 nm, and more preferably equal to or less than 1 nm. As the density of the intermediate layer, the intermediate layer may cover the entire base material, or the intermediate layer may be attached in a dotted or convex shape onto the base material, and a state where the intermediate layer is attached in a dotted shape onto the base material may be more efficient. The area ratio of (the portion including the intermediate layer/the portion including no intermediate layer) on the base material in such a case is not limited, and is preferably equal to or more than 0.01 and preferably equal to or less than 100, for example.

The method A and the method B described above have an effect of separating the fibrous carbon nanohorn aggregates even when used individually, but it is particularly preferable to combine these steps, that is, adopt the adhesion-assisted separation method of the present invention including both of the following steps:
providing a dispersion containing a carbon nanohorn aggregate mixture on a base material including, on a surface of the base material, an intermediate layer having a functional group that enhances adhesiveness to the fibrous carbon nanohorn aggregate, and
moving at least one of the dispersion provided on the base material or the base material. The separation of the fibrous carbon nanohorn aggregate from the spherical carbon nanohorn aggregate can be further improved by moving the dispersion on the base material including the intermediate layer, immersing the base material in the dispersion and moving the base material, or applying an external stimulus such as vibration, in addition to forming, onto the surface of the base material, the intermediate layer to which nanocarbon is likely to be adhered.

### (Method C)

The adhesion-assisted separation method of one example embodiment of the present disclosure includes providing, on a base material, a dispersion containing a carbon nanohorn aggregate mixture containing a fibrous carbon nanohorn aggregate that is subjected to a production of defects, a modification with a functional group that enhances adhesiveness to the base material, and/or bonding with a compound that enhances adhesiveness to the base material.

Horn portions of the fibrous carbon nanohorn aggregate and the spherical carbon nanohorn aggregate contain a large number of five-membered rings or seven-membered rings and have high reactivity. In a case where defects occur in these horn portions or a functional group or compound having high bonding/adhesion to the base material adheres to these horn portions, the reactivity is further improved, and the adhesiveness to the base material is enhanced. Since the fibrous carbon nanohorn aggregate has a larger ratio and number of horn portions in contact with the base material than the spherical carbon nanohorn aggregate, the effect of enhancing adhesiveness by the introduction of the defects, functional group, compound, and the like is higher. Accordingly, the difference in adhesion force between the fibrous carbon nanohorn aggregate and the spherical carbon nanohorn aggregate is further increased, so that the separation efficiency can be enhanced.

A method for preparing the carbon nanohorn aggregate mixture containing a fibrous carbon nanohorn aggregate having defects, a desired functional group, or a desired compound used in the present example embodiment will be described below. The introduction reaction of the defects, functional group, or compound can be performed on the carbon nanohorn aggregate mixture described above.

### Production of Defects and Functionalization Step

Since the horn portions of the fibrous carbon nanohorn aggregate contain a large number of five-membered rings or seven-membered rings, slight defects can be produced on the horn surfaces without deteriorating the electrically conductive characteristics by using an oxidation treatment or the like. The method for performing such an oxidation treatment is not particularly limited, and either a gas phase process or a liquid phase process can be used.

As for the gas phase process, the oxidation treatment is performed in an atmosphere of a gas such as oxygen, air, hydrogen peroxide, carbon dioxide, or carbon monoxide. The oxidation treatment temperature under a gas atmosphere is preferably 250° C. to 650° C., more preferably 300° C. to 500° C., and still more preferably 300° C. to 400° C. This is because oxidation hardly occurs in a case where the temperature is too low, and oxidation is too fast and control is difficult in a case where the temperature is too high. The treatment time may be appropriately adjusted, and for example, it is preferably within a range of about 5 hours to 7 hours at a temperature rising rate of 1° C./min.

As for the liquid phase process, the oxidation treatment is performed in a liquid containing an oxidizing substance such as nitric acid, sulfuric acid, a sulfuric acid-nitric acid mixed solution, hydrogen peroxide, or chloric acid. The oxidation treatment with these acids is performed at a temperature of about 0° C. to 180° C. in a case of using an aqueous solution system (the temperature is sufficient to be a temperature at which an aqueous solution exists as a liquid), or at a temperature at which a solvent to be used exists as a liquid in a case of using an organic solvent system. As for the nitric acid or the sulfuric acid, the temperature range is preferably from room temperature to 120° C. The hydrogen peroxide may be used within a temperature range of room temperature to 100° C., and the temperature range is more preferably equal to or higher than 40° C. The oxidizing power efficiently acts within a temperature range of 40° C. to 100° C. In particular, a temperature range of 50° C. to 80° C. is preferable. The treatment time may be appropriately adjusted, and is preferably within a range of about 0.5 hours to 3 hours. In the liquid phase process, it is more effective to use light emission in combination.

By the above-described oxidation treatment, it is possible to add a functional group such as a carbonyl group, a carboxyl group, a hydroxyl group, a nitro group, a sulfone group, a phenol group, an oxygen-containing functional group containing an ether bond or an ester bond, or an imino group to a 5-membered ring or a 7-membered ring at which a graphite surface is curved, such as a tip of a carbon nanohorn, or other highly reactive carbon sites.

In one example embodiment, it is preferable to carry out weak oxidation treatment and to avoid excessive oxidation. This is because, although oxidation is initiated at a highly reactive 5-membered ring or 7-membered ring that is present in a large amount at the tip portion by the oxidation treatment, excessive oxidation treatment may cause over-oxidation, leading to the removal of nanohorn tips, and as a result, capping with cyclodextrin described later is no longer possible or a nanohorn body may also be oxidized to generate pores, thereby causing changes in bulk properties of the carbon nanohorn aggregate.

The degree of the oxidation in this case is preferably set to such a degree that oxygen is contained at a ratio of preferably 1.0×10⁻⁵% by atomic fraction to 1.0×10⁰% by atomic fraction, more preferably 1.0×10⁻³% by atomic fraction to 1.0×10⁰% by atomic fraction with respect to the total carbon (100% by atomic fraction). Although various analysis methods may be used, the ratio of oxygen to carbon may be estimated from, for example, an intensity ratio of O1s to C1s obtained by X-ray photoelectron spectroscopy.

### Cyclodextrin Treatment

By bonding a compound that enhances adhesiveness to the base material to the fibrous carbon nanohorn aggregate, the adhesiveness of the fibrous carbon nanohorn aggregate to the base material can be further enhanced. Examples of such a compound include cyclodextrin.

By treating the carbon nanohorn aggregate mixture subjected to the above-described oxidation treatment with a cyclodextrin-containing solution, a hydrophilic carbon nanohorn aggregate mixture in which the nanohorn tip portions are capped with cyclodextrin can be produced. Since an oxygen-containing functional group is introduced at the tip portion of the carbon nanohorn aggregate, the tip portion interacts with an OH group of cyclodextrin, and specifically, forms hydrogen bonds, leading to the immobilization and stabilization of cyclodextrin.

Cyclodextrin (hereinafter, may be abbreviated as “CD”) is a cyclic oligosaccharide, is a non-reducing sugar in which glucose residues are linked by α-1,4 bonds to form a cyclic structure, and has a torus structure also called a bottomless bucket-structure or a crown-structure. The cyclodextrin has the hydrophobic interior, but is water-soluble because it has a large number of OH groups on the exterior.

Examples of the cyclodextrin include well-known cyclodextrins such as unsubstituted cyclodextrins containing 6 to 12 glucose units, depending on the difference in the number of constituting glucose units, particularly α-cyclodextrin, β-cyclodextrin, γ-cyclodextrin, and/or derivatives thereof, and/or mixtures thereof. α-Cyclodextrin is composed of 6 glucose units, β-cyclodextrin is composed of 7 glucose units, and γ-cyclodextrin is composed of 8 glucose units, each having a different cavity size from one another. In the present example embodiment, it is preferable to contain at least one selected from the group consisting of α-cyclodextrin, β-cyclodextrin, and γ-cyclodextrin.

In cyclodextrin treatment, an oxidation-treated carbon nanohorn aggregate mixture is brought into contact with cyclodextrin in a solution in which the cyclodextrin is dissolved. As the dispersion medium, a dispersion medium containing water or, in addition to water, a surfactant, a water-soluble organic solvent, and the like as necessary is used.

The addition amount of the cyclodextrin may be appropriately selected, and is, for example, 0.1 to 50 parts by mass and preferably 0.5 to 10 parts by mass with respect to 100 parts by mass of the carbon nanohorn aggregate mixture subjected to the oxidation treatment.

The treatment conditions are not particularly limited, and may be appropriately selected, for example, in a range of 0° C. to 100° C. and preferably in a range of 10° C. to 70° C. In one example embodiment, for example, a range of 15° C. to 60° C. close to room temperature is preferable. The treatment time may also be appropriately set, and for example, is equal to or longer than 10 minutes and preferably equal to or longer than 3 hours, and the upper limit is not particularly limited, and may be, for example, equal to or shorter than 10 days.

As described above, the oxygen-containing functional group at the tip portion of the carbon nanohorn aggregate and the hydroxyl group of the cyclodextrin interact with each other, and specifically, are immobilized through hydrogen bonding, to obtain a stabilized hydrophilic carbon nanohorn aggregate mixture. As a result of the hydrophilicity obtained, the dispersibility in an aqueous medium is improved.

The carbon nanohorn aggregate mixture that is obtained as described above and subjected to the production of defects on horn portions, the modification with a functional group that enhances adhesiveness to the base material, and/or the bonding with a compound that enhances adhesiveness to the base material exhibits high hydrophilicity. Therefore, in a case where the aforementioned carbon nanohorn aggregate mixture dispersion is prepared, there is also an advantage in that favorable dispersion in an aqueous dispersion medium is achieved without adding a surfactant, and monodispersion is facilitated.

It is particularly preferable to combine, with the method C of the present example embodiment, the step of moving the dispersion in the above-described method A relative to the base material. Accordingly, it is possible to reduce adhesion of the spherical carbon nanohorn aggregate, which has a weak adhesion force to the base material, to the base material and/or to detach or remove the spherical carbon nanohorn aggregate adhered to the base material.

It is preferable to combine, with the method C of the present example embodiment, the step of providing the intermediate layer having a predetermined functional group on a surface in the above-described method B on the base material. In this way, the difference in adhesion force between the fibrous carbon nanohorn aggregate and the spherical carbon nanohorn aggregate is further increased, and the separation efficiency can be thus further enhanced.

In one aspect, combining the method C with the method A and the method B can further enhance the separation efficiency of the fibrous carbon nanohorn aggregate.

### (Method D)

An adhesion-assisted separation method of one example embodiment of the present disclosure includes providing a carbon nanohorn aggregate mixture dispersion on a base material by spraying in an aerosol state.

In a case where the carbon nanohorn aggregate mixture in an agglomerated state adheres to the base material, it is difficult to separate the fibrous carbon nanohorn aggregate from the spherical carbon nanohorn aggregate by using a difference in the adhesion force to the base material. Given this factor, the present inventor has found that, by forming the carbon nanohorn aggregate mixture dispersion into aerosol, the fibrous carbon nanohorn aggregates and the spherical carbon nanohorn aggregates monodispersed in the dispersion can be sprayed while being maintained in a monodispersed state. In a case where this aerosol of the carbon nanohorn aggregate mixture is sprayed onto the base material, the fibrous carbon nanohorn aggregates and the spherical carbon nanohorn aggregates can be provided on the base material while being separated from each other in a monodispersed state as illustrated in FIG. 3. Accordingly, it is possible to separate the fibrous carbon nanohorn aggregates from the spherical carbon nanohorn aggregates by using a difference in adhesion force to the base material.

In the present specification, the phrase “adhering the fibrous carbon nanohorn aggregates and the spherical carbon nanohorn aggregates in a monodispersed state” means a state where the fibrous carbon nanohorn aggregates and the spherical carbon nanohorn aggregates are adhered to the base material while being separated for each aggregate (that is, a state where two or more fibrous carbon nanohorn aggregates and spherical carbon nanohorn aggregates are not agglomerated). In one example embodiment, it is preferable that the fibrous carbon nanohorn aggregates are in a monodispersed state in an amount equal to or more than 0.1% (number ratio), more preferable that the fibrous carbon nanohorn aggregates are in a monodispersed state in an amount equal to or more than 1% (number ratio), and still more preferable that the fibrous carbon nanohorn aggregates are in a monodispersed state in an amount equal to or more than 10% (number ratio). In one aspect, the upper limit of the ratio of the fibrous carbon nanohorn aggregates in a monodispersed state in the fibrous carbon nanohorn aggregates obtained by the adhesion-assisted separation method of the present disclosure is not limited, and may be 100%, and for example, may be equal to or less than 90%, equal to or less than 80%, or equal to or less than 70%. The ratio of the fibrous carbon nanohorn aggregates in a monodispersed state can be determined by applying the carbon nanohorn aggregate mixture dispersion onto the base material and counting each of the number of fibrous carbon nanohorn aggregates in a monodispersed state and the number of fibrous carbon nanohorn aggregates to which the spherical carbon nanohorn aggregates are adhered.

The size of individual droplets of aerosol is not particularly limited as long as a single droplet can contain the fibrous carbon nanohorn aggregate, and the diameter of a discharge port of an aerosol spray device is preferably equal to or more than 0.1 μm, and more preferably equal to or more than 0.5 μm. In a case where the diameter of the discharge port is equal to or more than 0.5 μm, a dispersed substance is less likely to be clogged in the discharge port.

From the viewpoint of providing the fibrous carbon nanohorn aggregates and the spherical carbon nanohorn aggregates in a monodispersed state to the base material and improving the separation performance of both, it is more effective that a droplet diameter is small, and for example, the droplet diameter is preferably equal to or more than 100 nm and more preferably equal to or more than 500 nm, and is preferably equal to or less than 50 μm and more preferably equal to or less than 10 μm. In a case where the aerosol droplet diameter is small, the number of carbon nanohorn aggregates contained in a single aerosol droplet is one or a few, so that the carbon nanohorn aggregates are provided on the base material in a dispersed state, and furthermore, the solvent of the aerosol droplet dries faster, resulting in reduction of the occurrence of agglomeration on the base material. The droplet diameter of aerosol can be measured as, for example, D50 in a particle size distribution obtained by using a laser diffraction particle size distribution measuring device.

The aerosol density is not particularly limited, and the aerosol density is preferably adjusted in such a way that the number of aerosol droplets per unit area when the aerosol droplets adhere to the base material is preferably equal to or more than 10⁴/mm² and more preferably equal to or more than 10⁵/mm², and from the viewpoint of maintaining monodispersion, the number of aerosol droplets is preferably equal to or less than 10⁸/mm² and more preferably equal to or less than 10⁷/mm².

The aerosol spray may be repeatedly or continuously carried out, and it is preferable that the next spray is carried out after the solvent of the aerosol droplets has dried on the base material to avoid agglomeration on the base material. Since the solvent drying rate is high as described above in a case where the aerosol droplet diameter is small, the time interval between repeated sprays can be shortened.

In one example embodiment, the aerosol droplets may be sprayed directly onto the base material, or may be carried by a gas stream at a constant speed to reach the base material. The gas type of the gas stream is not particularly limited, and a gas that does not react with the carbon nanohorn aggregate, such as air, nitrogen, argon, and helium, is preferable. Since the solvent of the aerosol droplets is dried while being moved by the gas stream, the carbon nanohorn aggregates can be supplied to the base material when the droplets reach the base material in a state where the droplet diameter becomes smaller or in a state where the carbon nanohorn assembly is completely dried and monodispersed.

The installation direction of the base material when the aerosol droplets are sprayed, the direction in which the aerosol droplets are sprayed (spray direction), the spray angle (spreading angle of liquid ejected from a nozzle), and the like are not limited. For example, the flat surface of the base material may be in the horizontal direction, may be inclined with respect to the horizontal direction, or may be installed to be in the vertical direction. The angle formed by the plane of the base material and the spray direction of the droplets (for example, the axial direction of a nozzle of an atomizer) may be any of 90° (vertical) to 0° (horizontal). For example, aerosol droplets may be supplied from an upward direction to a downward direction (for example, the vertical direction) of the plane of the base material that is horizontally placed. Alternatively, for example, the aerosol droplets may be sprayed from the side (from the horizontal direction) while the base material is held upright with the plane thereof oriented vertically. The angle between the base material and the spray direction of the aerosol droplets is not limited, and the angle between the plane of the base material and the axial direction of a nozzle body of the atomizer may be any angle of 90° (vertical) to 0° (horizontal), and may be appropriately selected. The spray angle (spread angle of liquid ejected from a nozzle) when the aerosol droplets are sprayed is not limited, and may be, for example, about 30° to 160°, and preferably about 40° to 80°.

Since the aerosol droplets are sprayed with velocity, the droplets relatively move even in a case where the base material is not moved, thereby enabling separation by a difference in adhesion force between the fibrous carbon nanohorn aggregate and the spherical carbon nanohorn aggregate to the base material.

In one example embodiment, it is particularly preferable to move the aerosol droplets of the carbon nanohorn aggregate mixture dispersion and/or the base material, that is, combine the above-described method D and the above-described method A. In a case where the aerosol droplets move relative to the base material, the adhesion of the droplets containing the spherical carbon nanohorn aggregates having weaker adhesion force and smaller contact areas with respect to the base material can be reduced with respect to the base material, and/or the droplets containing the spherical carbon nanohorn aggregates adhering to the base material can be detached or removed. As a result, it is possible to combine the separation effect obtained by the droplets adhering to the base material through the aerosol spraying of the method D without coalescence or agglomeration of the droplets and the separation effect obtained by the movement in the method A due to the difference in adhesion force between the fibrous carbon nanohorn aggregate and the spherical carbon nanohorn aggregate to the base material, and it is possible to further enhance the separation efficiency.

In the present example embodiment, since the aerosol droplets of the carbon nanohorn aggregate mixture dispersion and the base material are sufficient to be moved relative to each other, the base material may be moved, the aerosol droplets may be moved, or both of the base material and the aerosol droplets may be moved. As the form of movement, those exemplified in the method A can be applied.

As for the movement of the base material, the base material may be moved at the same time as spraying the aerosol, or may be moved after the aerosol droplets are brought into contact with the base material.

As for the movement of the aerosol droplets, the aerosol droplets adhered to the base material can be moved. As for the spraying of aerosol droplets, the aerosol droplets whose movement speed is adjusted by control of discharge pressure or the like can also be supplied to the base material. The separation efficiency can be enhanced by adjusting the angle between the plane of the base material and the spray direction, the intermediate layer, the solvent, the concentration of the carbon nanohorn aggregate mixture, and the like.

An example of a preferred example embodiment will be described, but the present example embodiment is not limited thereto.

The aerosol droplets of the carbon nanohorn aggregate mixture dispersion are sprayed onto the base material that is being rotated by a spin coater or the like. The fibrous carbon nanohorn aggregates and the spherical carbon nanohorn aggregates are present in the carbon nanohorn aggregate mixture dispersion in a monodispersed state. In a case where an aerosol is formed using this dispersion, the fibrous carbon nanohorn aggregates and the spherical carbon nanohorn aggregates are each contained in each droplet of the aerosol in a monodispersed state. In a case where these droplets are sprayed onto the base material, the droplets containing the fibrous carbon nanohorn aggregates and the droplets containing the spherical carbon nanohorn aggregates fall away from each other. At that time, since the base material is rotationally moved, the fibrous carbon nanohorn aggregates having stronger adhesion force remain on the base material, whereas the spherical carbon nanohorn aggregates having smaller adhesion areas are highly likely to be shaken off by a centrifugal force. As a result, it is possible to increase the ratio of the fibrous carbon nanohorn aggregates.

In one example embodiment, by combining the method (B) and/or the method (C) in addition to the method (D) and the method (A), the separation efficiency of the fibrous carbon nanohorn aggregate can be further increased.

### <Additional Step>

The separation method of the present disclosure may include additional steps. Examples thereof will be described below.

### Washing Step

The separation method of the present disclosure may include a step of washing, with a solvent, the base material to which the fibrous carbon nanohorn aggregates alone or the carbon nanohorn aggregate mixture having an increased ratio of the fibrous carbon nanohorn aggregates is adhered. This step may also serve as the step of “washing with a solvent” in the above-described (Method A).

By the washing step, the spherical carbon nanohorn aggregates on the base material is removed, and the ratio of the fibrous carbon nanohorn aggregates can be further increased.

In a case where a dispersion medium containing a surfactant is used as the dispersion medium of the carbon nanohorn aggregate mixture dispersion, the carbon nanohorn aggregate mixture on the base material is covered with the surfactant. Removing this surfactant by washing enables further utilization of the electrical conductivity of the fibrous carbon nanohorn aggregates.

Examples of such a solvent used in the washing step include water, ethanol, and 2-propanol.

### Heat-Treatment/Drying Step

The separation method of the present invention may include a step of heat-treating and/or drying the base material to which the fibrous carbon nanohorn aggregates alone or the carbon nanohorn aggregate mixture having an increased ratio of the fibrous carbon nanohorn aggregates is adhered.

The dispersion medium of the carbon nanohorn aggregate mixture dispersion can be removed by the heat treatment/drying step.

The surfactant used in the dispersion medium of the carbon nanohorn aggregate mixture dispersion can be removed by the heat-treatment step. The temperature of the heat treatment may be appropriately set to be equal to or higher than the decomposition temperature of the surfactant, and is preferably 150° C. to 500° C. and more preferably 160° C. to 500° C., for example, 180° C. to 400° C.

The carbon nanohorn aggregate can be subjected to heat treatment in a non-oxidizing atmosphere such as an inert gas, hydrogen, or vacuum to improve its crystallinity. The heat treatment temperature in this case can be 800° C. to 2,000° C., and is preferably 1,000° C. to 1,500° C.

As necessary, the functional group introduced into the defects in the above-described method C can also be removed by heat treatment. The heat treatment temperature in this case can be 150° C. to 2000° C. In order to remove carboxyl groups, hydroxyl groups, and the like, 150° C. to 600° C. is desirable. As for carbonyl groups and the like, it is desirable to employ a temperature that is equal to or higher than 600° C.

According to the above-described steps, it is also possible to produce a film containing the fibrous carbon nanohorn aggregates or the carbon nanohorn aggregate mixture having an increased ratio of the fibrous carbon nanohorn aggregates. Therefore, the adhesion-assisted separation method of the present invention can also be used as a method for forming a fibrous carbon nanohorn aggregate film or a carbon mixture film containing a fibrous carbon nanohorn aggregate in a desired ratio. The thickness, density, ratio of the fibrous carbon nanohorn aggregate, and the like of the film to be formed may be appropriately adjusted by adjusting the amount of the dispersion provided on the base material, the content and ratio of the fibrous carbon nanohorn aggregates, and the like.

### Recovery Step

As described above, it is preferable that the fibrous carbon nanohorn aggregates are separated by adhesion on the base material, and the fibrous carbon nanohorn aggregates are used in a state where the fibrous carbon nanohorn aggregate remains adhered to the base material, but in one aspect, the fibrous carbon nanohorn aggregates subjected to adhesion-assisted separation on the base material may be separated from the base material and then recovered. Examples of the recovery method include a method of immersing a base material to which fibrous carbon nanohorn aggregates subjected to adhesion-assisted separation are adhered (the base material may include spherical carbon nanohorn aggregates remaining thereon) in an organic solvent such as ethanol, and a method of immersing the base material in a solvent and adding a condition such as an ultrasonic wave under which the carbon nanohorn aggregates are likely to be dispersed in the solvent.

According to the adhesion-assisted separation method of the present disclosure, the ratio of the fibrous carbon nanohorn aggregates in the carbon nanohorn aggregate mixture can be increased. The ratio (CNB/CNHs ratio) (number ratio) of the fibrous carbon nanohorn aggregates to the spherical carbon nanohorn aggregates in the obtained carbon nanohorn aggregate mixture is preferably equal to or more than 0.01, more preferably equal to or more than 0.05, and still more preferably equal to or more than 0.1. The upper limit is not limited, and the fibrous carbon nanohorn aggregates can be isolated alone. In one aspect, the upper limit of the CNB/CNHs ratio (number ratio) in the carbon nanohorn aggregate mixture obtained by the adhesion-assisted separation method of the present disclosure is not limited, and may be, for example, equal to or less than 10, equal to or less than 5, or equal to or less than 1.

### EXAMPLES

Hereinbelow, the present invention will be described in more detail with reference to Examples, but the present invention is not limited to these Examples.

### Preparation Example 1

### <Preparation of Carbon Mixture>

In a chamber under a nitrogen atmosphere, a carbon target containing iron was subjected to CO₂ laser ablation to produce a carbon mixture. Specifically, a graphite target containing 1% by weight of iron was rotated at 1.5 rpm and continuously irradiated with a CO₂ laser. The energy density of the CO₂ laser was 50 kW/cm². The temperature in the chamber was set to room temperature, and the flow rate of nitrogen supplied into the chamber was adjusted to 10 L/min. The pressure in the chamber was controlled to 933.254 to 1266.559 hPa (700 to 950 Torr).

The obtained carbon mixture was subjected to thermogravimetric analysis. The fibrous carbon nanohorn aggregates and the spherical carbon nanohorn aggregates burned at about 560° C., and the graphite burned at about 640° C. As a result of thermogravimetric analysis, it was found that the amount of the graphite in the carbon mixture was about 20% by weight.

### <Removal of Graphite>

The carbon mixture was ultrasonically dispersed in ethanol at a concentration of 0.1 mg/ml, and the dispersion was left to stand for one day to recover about 50% of the supernatant. The supernatant was dried in an oven at 150° C. to obtain a solvent-free carbon mixture from which the graphite had been removed. This carbon mixture was observed by SEM, and as a result, the graphite was not observed, and a large amount of spherical carbon nanohorn aggregates and a small amount of fibrous carbon nanohorn aggregates were observed. The fibrous carbon nanohorn aggregate had a diameter of about 30 to 100 nm and a length of several micrometers to several tens of micrometers. Most of the spherical carbon nanohorn aggregates had a substantially uniform size within a diameter range of about 30 to 200 nm. The carbon mixture thus obtained was used as a carbon nanohorn aggregate mixture in the present example.

The supernatant was diluted to a concentration of 0.01 mg/ml, and a particle size distribution was measured by a dynamic light scattering method using the diluted supernatant. As a result, size distributions in a region of 100 nm to 600 nm and a region of 8 μm to 10 μm were detected. Since only the spherical carbon nanohorn aggregates and the fibrous carbon nanohorn aggregates were observed from the SEM photograph in this sample, it was found that the region of 100 nm to 600 nm included the spherical carbon nanohorn aggregates, and the region of 8 μm to 10 μm included the fibrous carbon nanohorn aggregates.

From these size distribution regions, it was found that the spherical carbon nanohorn aggregates and the fibrous carbon nanohorn aggregates were almost monodispersed or dispersed as several agglomerations in ethanol.

From the result of the particle size distribution measurement, it was found that the carbon nanohorn aggregate mixture after graphite removal contains the spherical carbon nanohorn aggregates at 94% by volume and the fibrous carbon nanohorn aggregates at 6% by volume. This result was converted into a number ratio by using (length of fibrous carbon nanohorn/diameter of spherical carbon nanohorn aggregate) to obtain a ratio (CNB/CNHs ratio) of 0.003 for the fibrous carbon nanohorn aggregates to the spherical carbon nanohorn aggregates.

### Comparative Example 1

The supernatant of the ethanol dispersion of the carbon nanohorn aggregate mixture from which the graphite was removed in Preparation Example 1 was used as a carbon nanohorn aggregate mixture dispersion, and 10 μl of the dispersion was added dropwise onto an Si substrate with a thermal oxide film and dried. SEM images are shown in FIG. 1. It was found that a large amount of spherical carbon nanohorn aggregates adhered to the fibrous carbon nanohorn aggregates in an agglomerated state. The number of fibrous carbon nanohorn aggregates and the number of spherical carbon nanohorn aggregates in the SEM images were counted, and the CNB/CNHs ratio was calculated to be 0.001 (average value of CNB/CNHs ratio in visual field of 10 μm×10 μm at random 10 points). This value was close to the value converted from the result of the particle size distribution measurement of the dynamic light scattering method.

### Reference Example A1 (Method A)

The carbon nanohorn aggregate mixture prepared in Preparation Example 1 was dispersed in ethanol at a concentration of 0.1 mg/ml to prepare a carbon nanohorn aggregate mixture dispersion.

The Si substrate with a thermal oxide film was washed with acetone and isopropyl alcohol (IPA), and treated with an oxygen plasma asher, and thereafter, 100 μl of the carbon nanohorn aggregate mixture dispersion was added dropwise and left to stand for 10 seconds, and the dispersion was then spread using a spin coater with centrifugal force at 500 rpm for 10 seconds to move the dispersion, while the substrate was dried at the same time. The obtained Si substrate was observed by SEM, the number of fibrous carbon nanohorn aggregates and the number of spherical carbon nanohorn aggregates in the SEM images were counted, and the CNB/CNHs ratio was calculated to be 0.005 (average value of CNB/CNHs ratio in visual field of 10 μm×10 μm at random 10 points).

### Example 1 (Method B+Method A)

The carbon nanohorn aggregate mixture prepared in Preparation Example 1 was dispersed in ethanol at a concentration of 0.1 mg/ml to prepare a carbon nanohorn aggregate mixture dispersion.

An Si substrate with a thermal oxide film was washed with acetone and IPA, treated with an oxygen plasma asher, immersed in an APTES aqueous solution (0.1% by volume), washed with water, and then dried by nitrogen blow to form an APTES intermediate layer having a thickness of 0.3 nm.

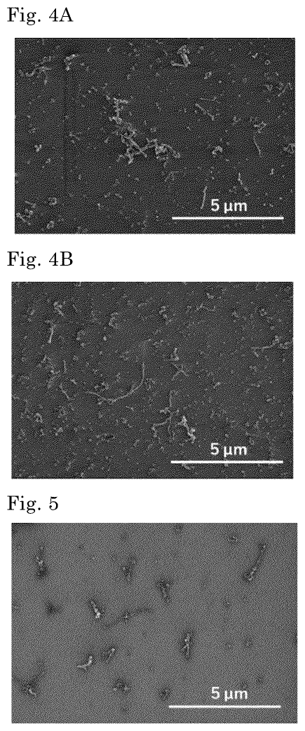

Onto the formed APTES intermediate layer, 100 μl of the carbon nanohorn aggregate mixture dispersion was added dropwise and left to stand for 10 seconds, and the dispersion was then spread using a spin coater with centrifugal force at 1,000 rpm for 10 seconds to move the dispersion, while the substrate was dried at the same time. An SEM image of the obtained Si substrate is shown in FIG. 4A. The number of fibrous carbon nanohorn aggregates and the number of spherical carbon nanohorn aggregates in the SEM images were counted, and the CNB/CNHs ratio was calculated to be 0.05 (average value of CNB/CNHs ratio in visual field of 10 μm×10 μm at random 10 points).

### Example 2 (Method B+Method A)

A carbon nanohorn aggregate mixture dispersion and an Si substrate on which an APTES intermediate layer was formed were used similarly as in Example 1.

Onto the formed APTES intermediate layer, 100 μl of the carbon nanohorn aggregate mixture dispersion was added dropwise, left to stand for one minute, and washed with water to move the dispersion (moving speed: about 0.5 m/s), and nitrogen blow drying was then performed. A SEM image of the obtained Si substrate is shown in FIG. 4B. The CNB/CNHs ratio calculated in the same manner as in Example 1 was 0.03.

Under both conditions of Examples 1 and 2, CNB and CNHs were separated and adhered to the substrate in a monodispersed state, and the CNB/CNHs ratio was increased as compared with the dispersion before the separation step.

### Example 3 (Method B+Method A)

A carbon nanohorn aggregate mixture dispersion and an Si substrate on which an APTES intermediate layer was formed were used similarly as in Example 1.

The Si substrate on which the APTES intermediate layer was formed was immersed in the carbon nanohorn aggregate mixture dispersion and then pulled out, droplets of the dispersion on the substrate was shaken off (acceleration: about 50 m/s²), and the substrate was dried by nitrogen blow. The CNB/CNHs ratio calculated in the same manner as in Example 1 was 0.05.

### Example 4 (Method B+Method A)

A carbon nanohorn aggregate mixture dispersion and an Si substrate on which an APTES intermediate layer was formed were used similarly as in Example 1.

The Si substrate on which the APTES intermediate layer was formed in the carbon nanohorn aggregate mixture dispersion was horizontally immersed, the substrate was horizontally rotated (rotation speed: 50 rpm, size of substrate: 10 mm×10 mm) and then pulled out, and the substrate was dried by natural drying. The CNB/CNHs ratio calculated in the same manner as in Example 1 was 0.01.

### Example 5 (Method B+Method A)

A carbon nanohorn aggregate mixture dispersion and an Si substrate on which an APTES intermediate layer was formed were used similarly as in Example 1.

The Si substrate on which the APTES intermediate layer was formed was immersed in the carbon nanohorn aggregate mixture dispersion in the vertical direction, the substrate was moved up and down (speed: 0.3 m/s) and then pulled out, and the substrate was dried by nitrogen blow. The CNB/CNHs ratio calculated in the same manner as in Example 1 was 0.02.

### Example 6 (Method B+Method A)

A carbon nanohorn aggregate mixture dispersion and an Si substrate on which an APTES intermediate layer was formed were used similarly as in Example 1.

The Si substrate on which the APTES intermediate layer was formed was immersed in the carbon nanohorn aggregate mixture dispersion in the horizontal direction, the dispersion was subjected to ultrasonic waves (conditions: 45 kHz, one minute), and the substrate was then pulled out and dried by nitrogen blow. The CNB/CNHs ratio calculated in the same manner as in Example 1 was 0.02.

### Comparative Example 2

The carbon nanohorn aggregate mixture prepared in Preparation Example 1 was dispersed in IPA at a concentration of 0.1 mg/ml to prepare a carbon nanohorn aggregate mixture dispersion.

A silver substrate was washed with acetone and IPA and treated with an oxygen plasma asher to prepare a silver substrate having no intermediate layer. Onto the silver substrate, 10 μl of the prepared dispersion was added dropwise and dried. According to the SEM observation, as shown in FIG. 1, it was found that a large amount of spherical carbon nanohorn aggregates adhered to the fibrous carbon nanohorn aggregates in an agglomerated state. The CNB/CNHs ratio calculated in the same manner as in Comparative Example 1 was 0.001.

### Example 7 (Method B+Method A)

A silver substrate was washed with acetone and IPA, treated with an oxygen plasma asher, then immersed in an IPA solution (0.2% by weight) of 10-carboxy-1 decanethiol that is a thiol compound, pulled out, and naturally dried to form an intermediate layer with a thickness of about 5 nm.

Onto the intermediate layer, 100 μl of the same carbon nanohorn aggregate mixture dispersion as in Comparative Example 2 was added dropwise, and left to stand for 10 minutes, droplets of the dispersion on the substrate was shaken off (acceleration: about 50 m/s²), and the substrate was dried by nitrogen blow. The CNB/CNHs ratio calculated in the same manner as in Example 1 was 0.03.

### Example 8 (Method C+Method A)

The carbon nanohorn aggregate mixture prepared in Preparation Example 1 was placed in a 30% by weight hydrogen peroxide solution, and subjected to a heat treatment at 70° C. for 30 minutes while being stirred, to produce defects in the carbon nanohorn aggregates. Thereafter, the carbon nanohorn aggregate mixture was filtered through a filter and washed with pure water 10 times. The carbon nanohorn aggregate mixture in which these defects were produced was dispersed in ethanol at a concentration of 0.1 mg/ml to prepare a defective carbon nanohorn aggregate mixture dispersion.

The Si substrate with a thermal oxide film was washed with acetone and IPA and treated with an oxygen plasma asher. While the Si substrate was rotated by a spin coater (condition: 500 rpm), 100 μl of the prepared defective carbon nanohorn aggregate mixture dispersion was added dropwise onto the substrate, and the dispersion was spread to move the dispersion, while the substrate was dried at the same time. The CNB/CNHs ratio calculated in the same manner as in Example 1 was 0.03.

### Example 9 (Method C+Method A+Method B)

A defective carbon nanohorn aggregate mixture dispersion similar to that in Example 8 was used. A Si substrate with a thermal oxide film was washed with acetone and IPA, treated with an oxygen plasma asher, immersed in an APTES aqueous solution (0.1% by volume), washed with water, and then dried by nitrogen blow to form an APTES intermediate layer having a thickness of 0.3 nm.

While the Si substrate was rotated by a spin coater (condition: 1,500 rpm), 100 μl of the defective carbon nanohorn aggregate mixture dispersion was added dropwise onto the formed APTES intermediate layer, and the dispersion was spread to move the dispersion, while the substrate was dried at the same time. The CNB/CNHs ratio calculated in the same manner as in Example 1 was 0.05.

In the SEM images of Examples 1 to 9, the number of fibrous carbon nanohorn aggregates in a monodispersed state (no spherical carbon nanohorn aggregates adhered) and the number of fibrous carbon nanohorn aggregates to which spherical carbon nanohorn aggregate were adhered were counted, and the ratio of the fibrous carbon nanohorn aggregates in a monodispersed state was calculated to be 0.002 to 0.001. The ratio was calculated according to the number of fibrous carbon nanohorn aggregates in a monodispersed state/(the number of fibrous carbon nanohorn aggregates in a monodispersed state+the number of fibrous carbon nanohorn aggregates to which spherical carbon nanohorn aggregates are adhered) (the same applies hereinafter).

### Example 10 (Method D+Method A)

The carbon nanohorn aggregate mixture prepared in Preparation Example 1 was dispersed in ethanol at a concentration of 0.1 mg/ml to prepare a carbon nanohorn aggregate mixture dispersion. The Si substrate with a thermal oxide film was washed with acetone and IPA and treated with an oxygen plasma asher.

While the Si substrate was rotated by a spin coater (condition: 1,000 rpm), the prepared carbon nanohorn aggregate mixture dispersion was aerosol-sprayed onto the substrate using a sprayer, while the substrate was dried at the same time. The D50 droplet diameter of the aerosol observed by a laser diffraction particle size distribution measuring device was 50 μm.

The CNB/CNHs ratio calculated in the same manner as in Example 1 was 0.08. In the SEM image, the number of fibrous carbon nanohorn aggregates in a monodispersed state and the number of fibrous carbon nanohorn aggregates to which spherical carbon nanohorn aggregate were adhered were counted, and the ratio of the fibrous carbon nanohorn aggregates in a monodispersed state was calculated to be 0.03 (the average value of the results in visual field of 10 μm×10 μm at random 10 points).

### Example 11 (Method D+Method A+Method B)

The carbon nanohorn aggregate mixture prepared in Preparation Example 1 was dispersed in ethanol at a concentration of 0.1 mg/ml to prepare a carbon nanohorn aggregate mixture dispersion.

An Si substrate with a thermal oxide film was washed with acetone and IPA, treated with an oxygen plasma asher, immersed in an APTES aqueous solution (0.1% by volume), washed with water, and then dried by nitrogen blow to form an APTES intermediate layer having a thickness of 0.3 nm.

While the Si substrate on which the APTES intermediate layer was formed was rotated by a spin coater (condition: 2,000 rpm), the prepared carbon nanohorn aggregate mixture dispersion was aerosol-sprayed onto the substrate using a sprayer, while the substrate was dried at the same time. The D50 droplet diameter of the aerosol observed by a laser diffraction particle size distribution measuring device was 50 μm.

The CNB/CNHs ratio calculated in the same manner as in Example 1 was 0.2. In the SEM image, the number of fibrous carbon nanohorn aggregates in a monodispersed state and the number of fibrous carbon nanohorn aggregates to which spherical carbon nanohorn aggregate were adhered were counted, and the ratio of the fibrous carbon nanohorn aggregates in a monodispersed state was calculated to be 0.1 (the average value of the results in visual field of 10 μm×10 μm at random 10 points).

### Example 12 (Method D+Method A+Method B)

A carbon nanohorn aggregate mixture dispersion and an Si substrate on which an APTES intermediate layer was formed were used similarly as in Example 11.

While the Si substrate on which the APTES intermediate layer was formed was rotated by a spin coater (condition: 2,000 rpm), the prepared carbon nanohorn aggregate mixture dispersion was aerosol-sprayed using a sprayer capable of producing a finer mist than that of Example 11, while the substrate was dried at the same time. The D50 droplet diameter of the aerosol observed by a laser diffraction particle size distribution measuring device was 5 μm.

A SEM image of the obtained Si substrate is shown in FIG. 5. The CNB/CNHs ratio calculated in the same manner as in Example 1 was 0.5. In the SEM image, the number of fibrous carbon nanohorn aggregates in a monodispersed state and the number of fibrous carbon nanohorn aggregates to which spherical carbon nanohorn aggregate were adhered were counted, and the ratio of the fibrous carbon nanohorn aggregates in a monodispersed state was calculated to be 0.5 (the average value of the results in visual field of 10 μm×10 μm at random 10 points).

### Example 13 (Method D+Method A+Method B)

A carbon nanohorn aggregate mixture dispersion and an Si substrate on which an APTES intermediate layer was formed were used similarly as in Example 11.

The Si substrate on which the APTES intermediate layer was formed was placed vertically against a horizontal surface, and the prepared carbon nanohorn aggregate mixture dispersion was aerosol-sprayed toward the substrate at an angle of about 45° using a sprayer, while the substrate was dried at the same time. The D50 droplet diameter of the aerosol observed by a laser diffraction particle size distribution measuring device was 50 μm.

The CNB/CNHs ratio calculated in the same manner as in Example 1 was 0.05. In the SEM image, the number of fibrous carbon nanohorn aggregates in a monodispersed state and the number of fibrous carbon nanohorn aggregates to which spherical carbon nanohorn aggregate were adhered were counted, and the ratio of the fibrous carbon nanohorn aggregates in a monodispersed state was calculated to be 0.1 (the average value of the results in visual field of 10 μm×10 μm at random 10 points).

The fibrous carbon nanohorn aggregates adhered to the Si substrates obtained in Examples 10 to 13 at a distance without agglomeration with the spherical carbon nanohorn aggregates as compared with Examples 1 and 2 (FIGS. 4A and 4B), and the CNB/CNHs ratio was also significantly higher than Examples 1 and 2. This result demonstrated that more effective CNB adhesion-assisted separation was possible by including the step of aerosol spraying and the step of moving the substrate or the dispersion.

While the invention has been described with reference to example embodiments and examples thereof, the invention is not limited to these embodiments and examples. Various changes that can be understood by those of ordinary skill in the art may be made to form and details of the present invention without departing from the spirit and scope of the present invention.

### [Supplementary Note]

Some or all of the above example embodiments may be described as the following Supplementary Notes, but the disclosure of the present application is not limited to the following Supplementary Notes.

### (Supplementary Note 1)

An adhesion-assisted separation method for a fibrous carbon nanohorn aggregate, the adhesion-assisted separation method including
providing a dispersion containing a carbon nanohorn aggregate mixture containing a fibrous carbon nanohorn aggregate on a base material including, on a surface of the base material, an intermediate layer having a functional group that enhances adhesiveness to the fibrous carbon nanohorn aggregate, and
moving at least one of the dispersion on the intermediate layer or the base material.

### (Supplementary Note 2)

An adhesion-assisted separation method for a fibrous carbon nanohorn aggregate, the adhesion-assisted separation method including
subjecting a fibrous carbon nanohorn aggregate to a production of defects, a modification with a functional group that enhances adhesiveness to a base material, and/or bonding with a compound that enhances adhesiveness to a base material,
providing, on the base material, a dispersion containing a carbon nanohorn aggregate mixture containing the fibrous carbon nanohorn aggregate subjected to the production of defects, the modification with a functional group that enhances adhesiveness to the base material, and/or the bonding with a compound that enhances adhesiveness to the base material, and
moving at least one of the dispersion on the base material or the base material.

### (Supplementary Note 3)

The adhesion-assisted separation method for a fibrous carbon nanohorn aggregate according to Supplementary Note 2, in which the base material includes, on a surface of the base material, an intermediate layer having a functional group that enhances adhesiveness to the fibrous carbon nanohorn aggregate.

### (Supplementary Note 4)

An adhesion-assisted separation method for a fibrous carbon nanohorn aggregate, the adhesion-assisted separation method including:
providing a dispersion containing a carbon nanohorn aggregate mixture containing a fibrous carbon nanohorn aggregate on a base material by spraying in an aerosol state.

### (Supplementary Note 5)

The adhesion-assisted separation method for a fibrous carbon nanohorn aggregate according to Supplementary Note 4, further including moving at least one of an aerosol droplet on the base material or the base material.

### (Supplementary Note 6)

The adhesion-assisted separation method for a fibrous carbon nanohorn aggregate according to Supplementary Note 4 or 5, in which the base material includes, on a surface of the base material, an intermediate layer having a functional group that enhances adhesiveness to the fibrous carbon nanohorn aggregate.

### (Supplementary Note 7)

The adhesion-assisted separation method for a fibrous carbon nanohorn aggregate according to any one of Supplementary Notes 4 to 6, in which the dispersion containing the carbon nanohorn aggregate mixture contains a fibrous carbon nanohorn aggregate subjected to a production of defects, a modification with a functional group that enhances adhesiveness to the base material, and/or bonding with a compound that enhances adhesiveness to the base material.

### (Supplementary Note 8)

The adhesion-assisted separation method for a fibrous carbon nanohorn aggregate according to any one of Supplementary Notes 1 to 7, in which the fibrous carbon nanohorn aggregate adheres to the base material in an amount equal to or more than 0.1% (number ratio) in a monodispersed state.

### (Supplementary Note 9)

The adhesion-assisted separation method for a fibrous carbon nanohorn aggregate according to any one of Supplementary Notes 1 to 8, in which a dispersion medium of the dispersion is an organic solvent, an aqueous solvent, or a mixed solvent of an organic solvent and an aqueous solvent.

### (Supplementary Note 10)

The adhesion-assisted separation method for a fibrous carbon nanohorn aggregate according to any one of Supplementary Notes 2, 3, and 7 to 9, in which the compound that enhances adhesiveness to a base material is cyclodextrin.

### (Supplementary Note 11)

The adhesion-assisted separation method for a fibrous carbon nanohorn aggregate according to any one of Supplementary Notes 2, 3, and 7 to 10, in which the functional group that enhances adhesiveness to the base material is selected from the group consisting of a carbonyl group, a carboxyl group, a hydroxyl group, a nitro group, a sulfone group, a phenol group, an ether bond, an ester bond, and an imino group.

### (Supplementary Note 12)

The adhesion-assisted separation method for a fibrous carbon nanohorn aggregate according to any one of Supplementary Notes 4 to 11, in which the base material is moved while the spraying of aerosol is performed.

### (Supplementary Note 13)

The adhesion-assisted separation method for a fibrous carbon nanohorn aggregate according to any one of Supplementary Notes 5 to 11, in which the base material is moved after the aerosol droplet is brought into contact with the base material.

### (Supplementary Note 14)

The adhesion-assisted separation method for a fibrous carbon nanohorn aggregate according to any one of Supplementary Notes 9 to 13, in which the aqueous solvent includes a surfactant.

### (Supplementary Note 15)

The adhesion-assisted separation method for a fibrous carbon nanohorn aggregate according to any one of Supplementary Notes 1 to 14, in which a concentration of the carbon nanohorn aggregate mixture in the dispersion is within a range of 10 μg/ml to 100 mg/ml.

### (Supplementary Note 16)

The adhesion-assisted separation method for a fibrous carbon nanohorn aggregate according to any one of Supplementary Notes 1, 3, and 6 to 15, in which the functional group that enhances adhesiveness to the fibrous carbon nanohorn aggregate is selected from the group consisting of a primary amino group, a secondary amino group, a tertiary amino group, an ammonium group, an imino group, an imide group, an amide group, an epoxy group, an isocyanurate group, an isocyanate group, a ureide group, a sulfide group, a mercapto group, a carboxy group, and a hydroxy group.

### (Supplementary Note 17)

The adhesion-assisted separation method for a fibrous carbon nanohorn aggregate according to any one of Supplementary Notes 1, 3, and 6 to 16, in which the intermediate layer is a layer comprising 3-aminopropyltriethoxysilane (APTES) or polylysine.

1. An adhesion-assisted separation method for a fibrous carbon nanohorn aggregate, the adhesion-assisted separation method comprising:
providing a dispersion containing a carbon nanohorn aggregate mixture comprising a fibrous carbon nanohorn aggregate on a base material comprising, on a surface of the base material, an intermediate layer having a functional group that enhances adhesiveness to the fibrous carbon nanohorn aggregate; and
moving at least one of the dispersion on the intermediate layer or the base material.

2. An adhesion-assisted separation method for a fibrous carbon nanohorn aggregate, the adhesion-assisted separation method comprising:
subjecting a fibrous carbon nanohorn aggregate to a production of defects, a modification with a functional group that enhances adhesiveness to a base material, and/or bonding with a compound that enhances adhesiveness to a base material;
providing, on the base material, a dispersion comprising a carbon nanohorn aggregate mixture comprising the fibrous carbon nanohorn aggregate subjected to the production of defects, the modification with a functional group that enhances adhesiveness to the base material, and/or the bonding with a compound that enhances adhesiveness to the base material; and
moving at least one of the dispersion on the base material or the base material.

3. The adhesion-assisted separation method for a fibrous carbon nanohorn aggregate according to claim 2, wherein the base material comprises, on a surface of the base material, an intermediate layer having a functional group that enhances adhesiveness to the fibrous carbon nanohorn aggregate.

4. An adhesion-assisted separation method for a fibrous carbon nanohorn aggregate, the adhesion-assisted separation method comprising:
providing a dispersion comprising a carbon nanohorn aggregate mixture comprising a fibrous carbon nanohorn aggregate on a base material by spraying in an aerosol state.

5. The adhesion-assisted separation method for a fibrous carbon nanohorn aggregate according to claim 4, further comprising moving at least one of an aerosol droplet on the base material or the base material.

6. The adhesion-assisted separation method for a fibrous carbon nanohorn aggregate according to claim 4, wherein the base material comprises, on a surface of the base material, an intermediate layer having a functional group that enhances adhesiveness to the fibrous carbon nanohorn aggregate.

7. The adhesion-assisted separation method for a fibrous carbon nanohorn aggregate according to claim 4, wherein the dispersion comprising the carbon nanohorn aggregate mixture comprises a fibrous carbon nanohorn aggregate subjected to a production of defects, a modification with a functional group that enhances adhesiveness to the base material, and/or bonding with a compound that enhances adhesiveness to the base material.

8. The adhesion-assisted separation method for a fibrous carbon nanohorn aggregate according to claim 4, wherein the fibrous carbon nanohorn aggregate adheres to the base material in an amount equal to or more than 0.1% (number ratio) in a monodispersed state.

9. The adhesion-assisted separation method for a fibrous carbon nanohorn aggregate according to claim 1, wherein a dispersion medium of the dispersion is an organic solvent, an aqueous solvent, or a mixed solvent of an organic solvent and an aqueous solvent.

10. The adhesion-assisted separation method for a fibrous carbon nanohorn aggregate according to claim 2, wherein the compound that enhances adhesiveness to a base material is cyclodextrin.

11. The adhesion-assisted separation method for a fibrous carbon nanohorn aggregate according to claim 5, wherein the base material comprises, on a surface of the base material, an intermediate layer having a functional group that enhances adhesiveness to the fibrous carbon nanohorn aggregate.

12. The adhesion-assisted separation method for a fibrous carbon nanohorn aggregate according to claim 5, wherein the dispersion comprising the carbon nanohorn aggregate mixture comprises a fibrous carbon nanohorn aggregate subjected to a production of defects, a modification with a functional group that enhances adhesiveness to the base material, and/or bonding with a compound that enhances adhesiveness to the base material.

13. The adhesion-assisted separation method for a fibrous carbon nanohorn aggregate according to claim 2, wherein the functional group that enhances adhesiveness to the base material is selected from the group consisting of a carbonyl group, a carboxyl group, a hydroxyl group, a nitro group, a sulfone group, a phenol group, an ether bond, an ester bond, and an imino group.

14. The adhesion-assisted separation method for a fibrous carbon nanohorn aggregate according to claim 7, wherein the functional group that enhances adhesiveness to the base material is selected from the group consisting of a carbonyl group, a carboxyl group, a hydroxyl group, a nitro group, a sulfone group, a phenol group, an ether bond, an ester bond, and an imino group.

15. The adhesion-assisted separation method for a fibrous carbon nanohorn aggregate according to claim 1, wherein the functional group that enhances adhesiveness to the fibrous carbon nanohorn aggregate is selected from the group consisting of a primary amino group, a secondary amino group, a tertiary amino group, an ammonium group, an imino group, an imide group, an amide group, an epoxy group, an isocyanurate group, an isocyanate group, a ureide group, a sulfide group, a mercapto group, a carboxy group, and a hydroxy group.

16. The adhesion-assisted separation method for a fibrous carbon nanohorn aggregate according to claim 3, wherein the functional group that enhances adhesiveness to the fibrous carbon nanohorn aggregate is selected from the group consisting of a primary amino group, a secondary amino group, a tertiary amino group, an ammonium group, an imino group, an imide group, an amide group, an epoxy group, an isocyanurate group, an isocyanate group, a ureide group, a sulfide group, a mercapto group, a carboxy group, and a hydroxy group.

17. The adhesion-assisted separation method for a fibrous carbon nanohorn aggregate according to claim 6, wherein the functional group that enhances adhesiveness to the fibrous carbon nanohorn aggregate is selected from the group consisting of a primary amino group, a secondary amino group, a tertiary amino group, an ammonium group, an imino group, an imide group, an amide group, an epoxy group, an isocyanurate group, an isocyanate group, a ureide group, a sulfide group, a mercapto group, a carboxy group, and a hydroxy group.

18. The adhesion-assisted separation method for a fibrous carbon nanohorn aggregate according to claim 1, wherein the intermediate layer is a layer comprising 3-aminopropyltriethoxysilane (APTES) or polylysine.

19. The adhesion-assisted separation method for a fibrous carbon nanohorn aggregate according to claim 3, wherein the intermediate layer is a layer comprising 3-aminopropyltriethoxysilane (APTES) or polylysine.

20. The adhesion-assisted separation method for a fibrous carbon nanohorn aggregate according to claim 6, wherein the intermediate layer is a layer comprising 3-aminopropyltriethoxysilane (APTES) or polylysine.
